(19) United States
(12) Patent Application Publication
(10) Pub. No.: US 2022/0032096 A1
(43) Pub. Date: Feb. 3, 2022

(54) FACEMASK FILTER ASSEMBLY

(71) Applicant: Augustine Biomedical + Design, LLC, Eden Prairie, MN (US)

(72) Inventors: Scott D. Augustine, Deephaven, MN (US); Dan Fredrick Grewe, Falcon Heights, MN (US); Garrett J. Augustine, Deephaven, MN (US); Brent M. Augustine, Savage, MN (US); Randall C. Arnold, Minnetonka, MN (US)

(21) Appl. No.: 17/079,015

(22) Filed: Oct. 23, 2020

Related U.S. Application Data
(60) Provisional application No. 63/059,691, filed on Jul. 31, 2020.

(51) Int. Cl. A62B 23/02; B01D 39/16; B01D 46/00; B01D 46/10; A41D 13/11; A62B 18/02

(52) U.S. Cl. CPC A62B 23/025; B01D 39/1623; B01D 46/0032; B01D 46/10; A41D 13/1107; B01D 2239/0435; B01D 2239/0627; B01D 2239/0622; B01D 2239/0618; B01D 2239/065; B01D 2271/02; A62B 18/025

(57) ABSTRACT

A facemask filter assembly including a layer of air filter material configured to fit inside of a surgical-type facemask. The filter assembly further including a strip of compressible foam that is coupled to the layer of air filter material near the edge (e.g., perimeter, periphery) of the layer of air filter material. The strip of compressible foam can extend around the entire perimeter of the layer of air filter material except for a gap at the midline of the upper edge of the layer of air filter material where the strip of compressible foam is absent creating a space to accommodate the nose of the user.

### PRIORITY

This application claims the benefit of priority to U.S. Provisional Patent Application Ser. No. 63/059,691, filed Jul. 31, 2020, which is incorporated by reference in its entirety.

### TECHNICAL FIELD

This document pertains generally, but not by way of limitation, to systems and methods for improving safety of healthcare workers and other personnel by protecting them from airborne pathogens and contaminates.

### BACKGROUND

The COVID-19 pandemic has made the wearing of facemasks mandatory for healthcare providers. Additionally, many states are requiring everyone to wear facemasks in all indoor public spaces. The mandatory wearing of facemasks such as medical procedure masks, surgical masks and home-made sewn cloth masks has been very controversial because many studies have shown that these masks provide the wearer almost no protection from aerosolized pathogens. In other words, none of these standard, common masks provide virtually any filtration of the inspired air.

### Overview

There is a need for an improved facemask for health care workers and anyone else desiring personal respiratory protection, that is comfortable to wear during extended use, efficient and effective in filtration, forms an excellent seal with the user's face, is inexpensive and does not fog the user's glasses. During a pandemic such as COVID-19 that is causing a world-wide shortage of personal protective equipment (PPE) such as face masks, a simple design that does not require long lead time tooling or custom long lead time manufacturing equipment is desirable.

The filter material in medical procedure masks is very poor quality and is only tested for its ability to block blood and fluid sprays. The bigger reason for the filtering failure of medical procedure masks, is that they massively leak air around their edges. Unfiltered inspired and exhaled air easily passes through the gaps between the mask and the face and is not forced through the filter. Cloth masks in general do not filter at all and may or may not be able to block blood and fluid sprays.

Medical procedure masks, surgical masks and home-made sewn cloth masks may provide some protection to everyone but the wearer by blocking some of the aerosolized particles and droplets in the wearer's exhaled breath. This phenomenon is known as “source control.” Filtered facemasks, especially those for medical use during surgery for example, are intended primarily to protect the patient from the healthcare provider. In other words, filtered facemasks prevent airborne droplets that may contain bacteria and viruses from the clinician's mouth and nose, from spraying into an open surgical wound. To prevent droplets from aerosolizing outward, a tight seal around the nose and mouth is not necessary. Additionally, since the droplets are relatively large, filter material or filter media that is relatively inefficient in filtration is adequate.

Absent a tight seal around the periphery of the nose and mouth and absent high efficiency filter media, these filtered face masks provide very little protection for the healthcare provider or anyone else trying to avoid airborne pathogens such as those airborne viruses present during the COVID-19 pandemic.

If personal protection is the goal—protecting yourself against aerosolized pathogens, higher filter efficiency facemasks such as so-called N-95 and N-100 masks are necessary. In addition to higher efficiency filter media, these masks are also designed to create a better seal around the nose and mouth. Most of these high efficiency masks are a molded design and are somewhat inflexible, requiring specific fitting to the user's face. If the mask is not properly fitted and is not tightly applied, usually with two elastic bands behind the head and neck, air can leak around the periphery, which entirely negates the purpose of the high efficiency filter media. The tight fit of these masks makes them uncomfortable for prolonged use. These masks are well known to leak air between the mask and face even under the best circumstances.

There is a need for comfortable, high efficiency facemasks and respirators in many walks of life, especially during a pandemic like Covid-19. The facemasks and respirators must include high efficiency filters and excellent seals between the filters and the face in order to provide the user with reliable protection.

Prior art adjunct filters have been developed in order to improve the filtration efficiency of prior art facemasks. Typically, these insertable filters are generally rectangular in shape with rounded upper and lower edges. Prior art adjunct filters suffer from the same problem as the mask that they are inserted into: they leak air around the edges. Therefore, no matter what quality the filter may be, the unfiltered air leaking around the edges negates most of the benefit of these adjunct filters.

In some examples, the invention of this disclosure is a removable filter that can be added to prior art face masks, including but not limited to disposable medical procedure masks, surgical masks and sewn cloth masks and neck gators. In some examples, the filter can be made of high efficiency filter material in order to improve the filtration efficiency of the facemask. The filter also includes a gasket attached near some or all of the periphery of the filter. The gasket provides an improved seal between the filter and the face of the user, in order to prevent unfiltered air from leaking between the filter and the face.

Removable adjunct filters comprising one or more layers of filter material that can be inserted into prior art facemasks are well known. These adjunct filters are available in many degrees of filtration efficiency, ranging from modified coffee filters up to high efficiency filters. None of the adjunct filters include a means to improve the seal between the filter and the face of the user. Specifically, none of the adjunct filters include a gasket seal. Additionally, none of the prior art disposable medical procedure masks, surgical masks and sewn cloth masks and neck gators include a gasket seal to improve the seal between the filter and the face of the user.

In some examples, the filter might be made of a high efficiency filter media such as Technostat T-200, but many other filter medias are anticipated. In some examples, the filter may be a simple rectangular design or a rectangle with a rounded upper edge to accommodate the nose.

In some examples, the gasket might be a strip of foam rubber or foam plastic adhered near the periphery of the filter. In some examples, the gasket might be approximately 0.4 inches wide and 0.4 inches high. In some examples, the gasket might be made of expanded closed cell polyvinyl chloride/acrylonitrile butadiene blended foam rubber, although other rubbers and plastics are anticipated.

In some examples, the gasket may be proximate the entire periphery of the filter. In some examples, the gasket may be proximate the entire periphery of the filter except for a void in the gasket at the top center of the filter for accommodating the nose. The void in the gasket allows the filter to wrap snuggly around the tip of the nose applying the gasket ends that are adjacent to the void, substantially horizontally to each side of the nose. The wrapping action of the filter around the tip of the nose uniquely forces the adjacent gasket ends firmly against the sides of the nose for a good seal.

In some examples, the gasket at the lower edge of the filter uniquely seats against the face just above the chin bone, against the roots of the lower incisor teeth for the best seal. This is in contrast to prior art facemasks that extend under the chin and therefore do not have any defined structure under the jaw to create a seal against.

In some examples, wrapping the filter around the tip of the nose and elevating the filter off of the chin by the height of the gasket at the chin, elevates the filter off of the lips and mouth adding significantly to the comfort factor compared to prior art facemasks. The gasket surrounding the periphery of the filter not only elevates the filter off of the face but also creates a “breathing chamber” between the face and the filter. In addition to added comfort, the breathing chamber can allow the entire surface of the filter to engage in air exchange and filtering. This is in contrast to filters and facemasks that rest against the lips and mouth, limiting the useful filter surface to the small surface immediately in front of the mouth. The increased filter surface engaged in air exchange makes the resistance to breathing less and the filtration efficiency greater for any given filter material.

Creating a seal at the bridge of the nose and another seal above the chin bone means that the height of the filter may need to be able to accommodate a variety of facial sizes or multiple sizes may need to be supplied. Multiple sizes add to the logistical complexity of any product and it is generally advantageous if multiple sizes can be avoided. A substantially flat lower edge allows the gasket at the lower edge to be bent upward to accommodate faces with a shorter nose-to-chin distance. In other words, the gasket along the substantially flat lower edge allows the filter to be uniquely adjustable for multiple facial sizes. As the lower edge gasket bends upward to accommodate a smaller face, the side edges easily pull inward to accommodate the bend.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 shows a front view of a prior art filter insert, in accordance with at least one example.

FIG. 2 shows a back view of an example of a filter assembly, in accordance with at least one example.

FIG. 3 shows a back view of a second example of a filter assembly, in accordance with at least one example.

FIG. 4 shows a top cross sectional view of a filter assembly and facemask on a user's head at nose level (such as a cross section taken along line 4-4 of the filter assembly in FIG. 3), in accordance with at least one example.

FIG. 5 shows a back view of a third example of a filter assembly, in accordance with at least one example.

FIG. 6 shows a vertical section of an example filter assembly with a cup-shaped filter, in accordance with at least one example.

FIG. 7 shows a front view of an example of a user wearing a facemask and a filter assembly.

FIG. 8 shows a back view of a second example of a filter assembly, in accordance with at least one example.

### DETAILED DESCRIPTION

The following detailed description is exemplary in nature and is not intended to limit the scope, applicability, or configuration of the invention in any way. Rather, the following description provides practical illustrations for implementing exemplary examples of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

Reference will now be made in detail to embodiments of the disclosure, examples of which are illustrated in the accompanying drawings. The same reference numerals generally refer to the same or like components throughout the drawings. Relative terms, such as, “substantially” or “about” are used to indicate a possible variation, for example, of ±10% in a stated numeric value. As defined herein, the use of the terms “or” or “and” includes “or”, “and” or “and/or”. Directional descriptors are used within their ordinary meaning in the medical arts.

In some examples, the invention of this disclosure is a removable filter assembly that can be added to a face mask, including but not limited to disposable medical procedure masks, surgical masks and sewn cloth masks and neck gators. The filter assembly also includes a gasket attached near some or all of the periphery of the filter. The gasket provides an improved seal between the filter and the face of the user, in order to prevent unfiltered air from leaking between the filter and the face.

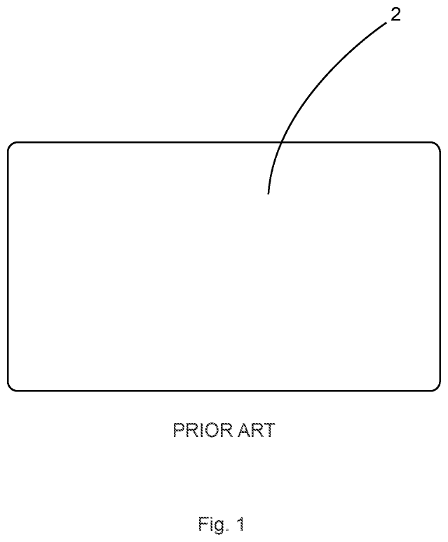

FIG. 1 shows a front view of a conventional filter insert. As shown in FIG. 1, removable adjunct filters 2 comprising one or more layers of filter material that can be inserted into an existing facemask. None of the conventional adjunct filters include a means to improve the seal between the filter 2 and a face of a user. Specifically, none of the adjunct filters include a gasket seal.

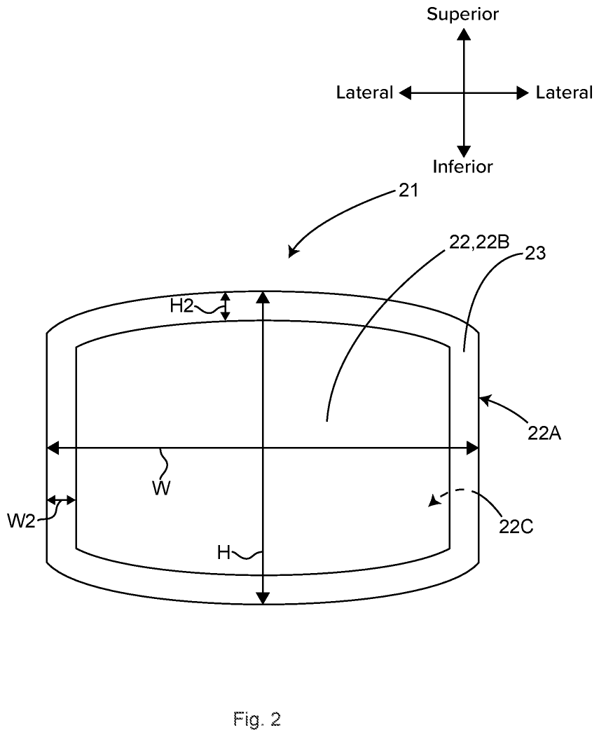

In some examples as shown in FIG. 2, the filter assembly 21 can include a filter 22 such as a layer of air filter material and a gasket 23. The filter 22 can be any suitable shape such as a rectangle of filter material with rounded upper and lower edges. The gasket 23 can be made of a strip of foam such as foam rubber or foam plastic or any other suitable gasket material. The gasket 23 can be adhered near the periphery 22A of the filter 22, the periphery 22A defining a perimeter length. In some examples, near the periphery can include most of the strip being positioned within 0-1 inch of the periphery. In a possibly more preferred example, most of the strip can be positioned within 0-0.25 inches of the periphery. Near the periphery can include at the periphery. In some examples, near the periphery can include at least a portion of the strip being attached to the filter material near the periphery and extending beyond the periphery. Other shapes including but not limited to rectangles, modified rectangles, lunar, oval, circular, irregular and combinations thereof can also be provided. In some examples, the layer of air filter material can be planar or substantially planar. In some examples, the layer of air filter material can be planar prior to coupling the filter material to the gasket (e.g., in a pre-assembled state). In some examples, the gasket can be planar or substantially planar. In some examples, the gasket can be planar prior to coupling the gasket to the layer of air filter material (e.g., in a pre-assembled state).

The filter assembly 21 can be elongate or substantially oval with the width W being longer than the height H. This is in contrast to other gasketed respirators that have a longer height H than a width W, such as those designed to form a seal below the chin. In addition, the layer of filter material (e.g., filter 22) can have a substantially uniform cross-section in a superior-inferior and anterior-posterior plane that is perpendicular to a plane of the layer of air filter material (e.g., superior-inferior and lateral-lateral plane). See FIGS. 2, 6 and 7 for general description of coordinate system.

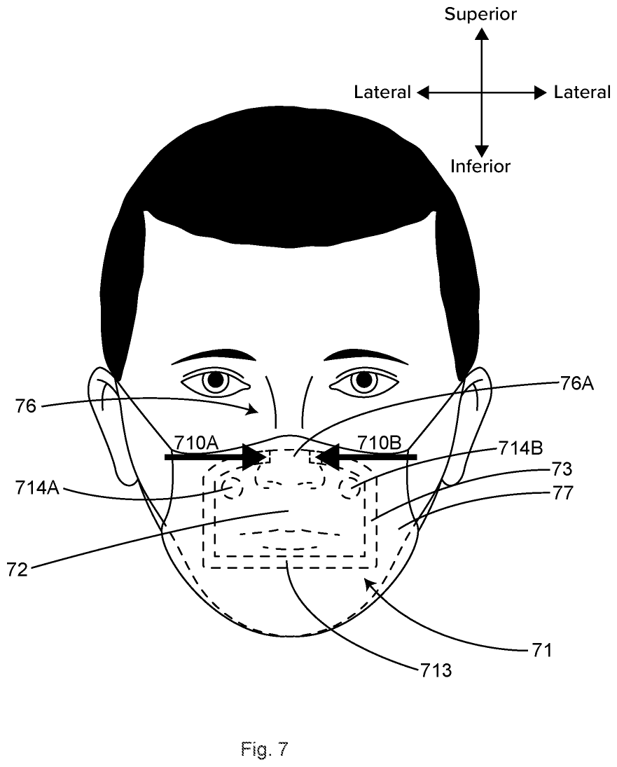

The height H can be equal to or greater than a distance between a midlevel of a nose and a top of a chin bone of a user, and the width W can be greater than a distance from a first corner of a mouth of the user to a second corner of the mouth of the user. In some examples, the filter 22 may have a height H approximately 2 to 6 inches high (e.g., superior-inferior direction) and a width W 4 to 7 inches wide (e.g., in a medial-lateral direction). In some examples, the filter 22 may have a height H of approximately 3.5 inches high and 5.5 inches wide. An example of superior, inferior and lateral directions is shown in FIG. 7, with the medial direction being inward from the lateral directions.

In some possibly more preferred examples, to cover a range of different user sizes, the filter height H may be approximately 3 inches, such as for small women and children. In some examples, the filter height H may be approximately 3⅜ inches tall, such as for large women and small men. In some examples, the filter height H may be approximately 3¾ inches, such as for large men. In some examples, the width W of the filter is considerably wider than the width of the user's mouth to provide added filter area to make breathing easier. In some examples, the width W can be about 5½ inches, or in a range between 4.5 to 6.5 inches, or possibly more preferred between 5 to 6 inches. In some examples, the width W is at least 1.25 times the height H. In some examples, to cover a range of users, the width W is between 1.4 and 1.9 times longer than the height H.

Some of the benefits of the filter assemblies described herein is that they increase the square area of the filter size for easier breathing. The arrangement seats the gasket along (e.g., on) the relatively flat portion of the cheeks (e.g., along the cheekbone and lateral cheeks) rather than adjacent the mouth where the contours of the face are more severe, more dynamic with mouth movement and thus more challenging. The cheeks also provide a more stable tissue and bone structure to support a gasket that is less likely to create a leak. The laterally elongate shape of the filter assembly 21 shown in FIG. 2 also moves the gasket 23 away from the corners of the mouth laterally so that talking and smiling do not disrupt the seal or annoy the wearer as occurs with conventional facemasks.

In some examples, the filter 22 of this disclosure is made of high efficiency filter material in order to improve the filtration efficiency of any facemask. In some examples, the filter 22 might be made of a high efficiency filter media such as Technostat T-200Plus (Superior Felt and Filtration, McHenry, Ill.). In some examples, high efficiency filter media such as T-200Plus can be made with polypropylene fibers or a blend of polypropylene and polyester fibers. In some examples, the composition of the fibers in the filter may create a natural electrostatic charge that can attract oppositely charged airborne particles—so called “electrostatic” filtration. Other types of filter media are also anticipated.

In some examples, the filter 22 may be a laminate of layers including fibrous fabrics, although the laminate can also include non-fibrous fabrics, woven or non-woven materials. In some examples, the filter 22 can include a layer of high efficiency filter material can be laminated to a layer of meltblown polypropylene fabric in order to protect the layer of high efficiency filter material from the damaging effects of salt such as NaCl loading during NIOSH testing. A layer of 20 grams per square meter (gsm) to 40 gsm meltblown polypropylene fabric can be used. The layer of meltblown fabric will decrease the breathability of the filter laminate but may make the filter N-95 compliant so that it can be used in OSHA-regulated high-risk healthcare settings. The layer of meltblown polypropylene fabric can be located on the front face 22C of the filter 22. In some examples, the filter 22 can include the layer of high efficiency filter material laminated to a layer of spunbond polypropylene or polyester fabric in order to protect the user from inhaling fibers that may flake off of the high efficiency filter material. For example, the filter 22 can include the layer of air filter material laminated to a layer of spunbond scrim fabric such as polypropylene or polyester fibers. The laminate layer of spunbond scrim fabric can cover at least a portion of a backside (e.g., 22B) of the layer of air filter material that is directly in front of the user's mouth. These thin scrim fabrics may be 10 gsm to 30 gsm in weight and add very little resistance to breathing.

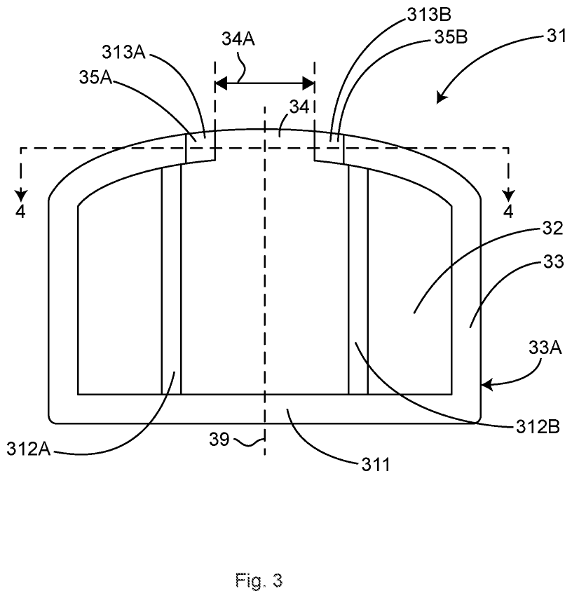

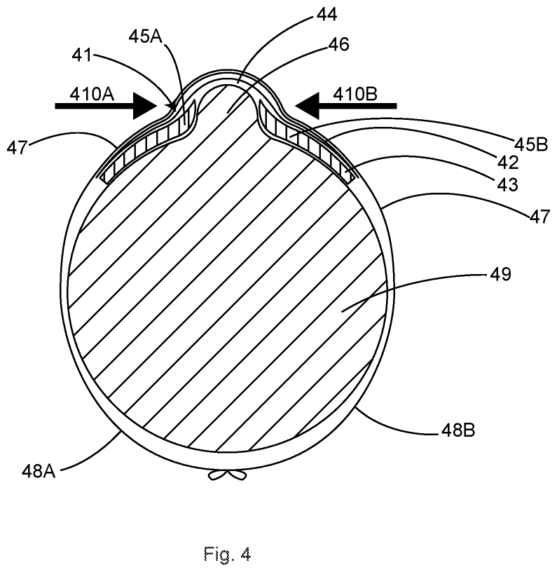

FIG. 3 shows a back view of a second example of a filter assembly 31. In some examples, as shown in FIG. 3, the filter assembly 31 may be a simple rectangular design with a rounded upper edge to accommodate a user's nose 46 (FIG. 4). Other shapes including but not limited to rectangles, modified rectangles, lunar, oval, circular, irregular and combinations thereof can also be provided.

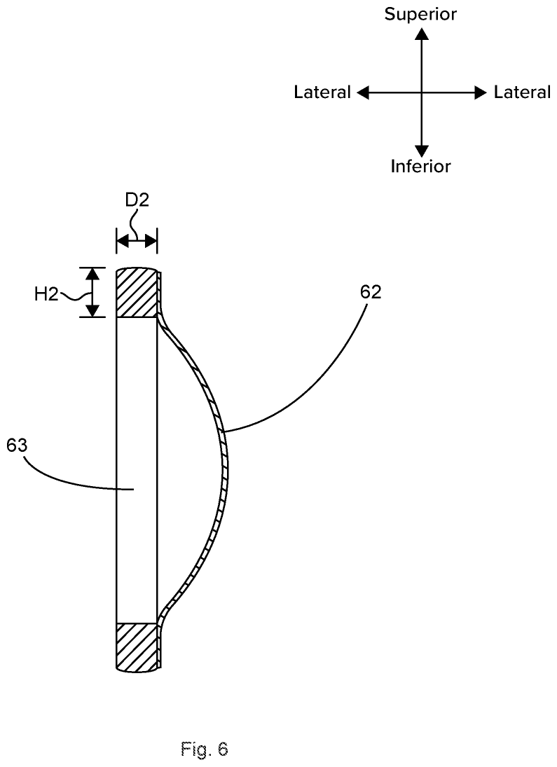

In some examples, as shown in FIG. 6 a filter assembly 61 including a filter 62 may be cut and sewn into a substantially cup shape, or the filter 62 may be molded into a substantially cup shape. Such cup shaped filters may be bonded around some or all of their periphery to gasket 63.

In some examples, as shown in FIGS. 2 and 3, a gasket 23,33 is coupled, such as by bonding or other coupling means, to the filter 22,32 near the periphery of the filter 22,32. The gasket 23,33 may circle the entire periphery of the filter 22,32 as in FIG. 2 or may have a void 34 as shown in FIG. 3 where the gasket 33 is absent. In some examples, the gasket 33 may be a strip of foam rubber or foam plastic adhered near the periphery of the filter 22,32. Molded rubber, plastic or silicone gaskets 23,33 are also anticipated. The gasket 23,33 may be bonded to the filter 22,32 by adhesives, hot-melt adhesives, or pressure sensitive adhesives (PSA) sometimes referred to as “two faced tape. Other bonding methods such as RF sealing, ultrasound sealing and heat sealing are anticipated. Although the examples shown include a void, some examples can include other aspects of the disclosure with a different void or no void.

In some examples, the gasket 23,33 may be a die-cut strip of foam rubber or foam plastic adhered near the periphery of the filter 22,32. In some examples, the foam rubber or foam plastic gasket 23,33 may be closed cell foam rubber or foam plastic in order to prevent the absorption of sweat or other liquids. In some examples, the gasket 23,33 may a height H2 between 0.25 inches and 0.75 inches, a width between 0.25 and 0.75 inches, and a depth D2 between 0.25 inches and 0.75 inches (depth D2 shown in FIG. 6). In some examples, the gasket 23,33 may have a height H2 of approximately 0.4 inches, a width W2 of approximately 0.4 inches, and a depth D2 of approximately 0.4 inches. In some examples, the gasket 23,33 may be made of expanded closed cell polyvinyl chloride/acrylonitrile butadiene blended foam rubber. Other rubbers and plastics including but not limited to PVC, polyethylene, neoprene, urethane, silicones and blends thereof are anticipated for the gasket 23,33.

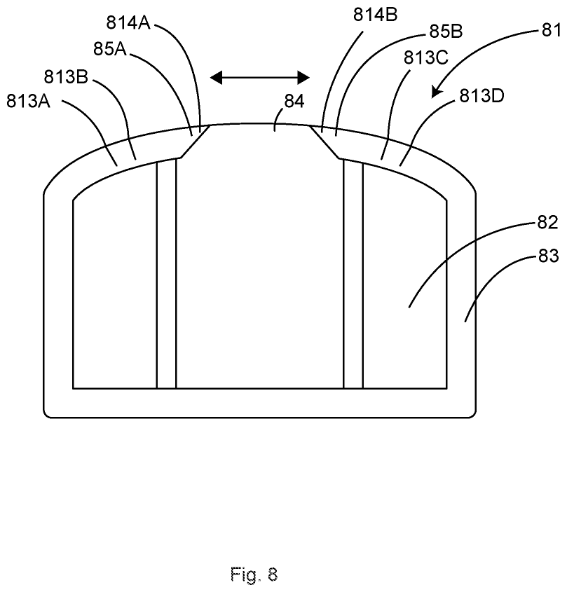

The relatively small cross section of the gasket 23,33 (compared to other prior art respirators) and the compressibility and flexibility of the gasket material, allows the gasket 23,33 to be highly conformable to the contours of the face. Instead of the gasket 23,33 being a uniform height along its length, in some examples the surface of the gasket that engages the face of the user may be sculpted to make a better seal with the contours of the face. For example, it may be advantageous to increase the height of the gasket in the areas corresponding with indentations in the facial topography such as the transition angle between the nose and the cheeks, or even the portions engaging the cheeks themselves, which may be “sunken.” In some examples as shown in FIG. 8, one or more partial thickness or full thickness transverse cuts 813A-D may be made in the gasket to improve its ability to bend and contour to the curves of the face. In some examples, the partial thickness transverse cuts 813A-D may extend diagonally from the lower inside corner to the upper outside corner of the gasket, including the upper inside corner, leaving the lower inside corner edge intact to form a seal against the face.

In some examples as shown in FIG. 3, the gasket 33 may be proximate the entire periphery of the filter 32 except for a void 34 such as a discontinuity, cutout, gap 34A in the gasket 33 at the top center (e.g. along the midline 39 at an upper edge of the periphery 33A) of the filter 32 for accommodating the nose of the user.

FIG. 4 shows a top cross sectional view of a filter assembly 41 including filter 42, and a facemask 47 on a user's head at nose 46 level (such as along the cross section taken along line 4-4 in FIG. 3). The cross section of FIG. 4 is taken along the mid-level of the nose 46 between the tip and the radix. More specifically, the cross section of FIG. 4 is taken along the mid-level of the nose 46 at a location between the nostrils and the rhinion (e.g., above the alar groove and below the rhinion). An example of a mid-level 76A of a nose 76 is shown in FIG. 7. The cross-section through the mid-level of the nose 46 can also be described as being through one or more of the following: the upper cartilage, through the inferior portion of the upper cartilage, through the lower cartilage, through the superior portion of the lower cartilage, through the junction of the upper cartilage and the lower cartilage or superior of the lower cartilage.

In some examples, the void 44 such as a discontinuity, cutout or gap in the gasket 43 is about 0.375 to 2.0 inches wide in a lateral direction (see axes in FIG. 7). The void 44 can allow the filter 42 to wrap snuggly around the tip of the nose 46 preventing air leaks at that location. Wrapping the filter around the face and the tip of the nose 46, orients the gasket ends 45A,B that are adjacent to the void 44, substantially horizontally along each side of the nose 46 (e.g., lateral side). Wrapping the filter 42 around the tip or bridge of the nose 46 effectively creates a hinge point at the nose 46 along a superior-inferior direction that uniquely forces, as shown by force 410A,410B, the adjacent gasket ends 45A,45B firmly against the sides of the nose 46, thereby applying a force medially to the nose 46 (also see medial forces 710A,710B in FIG. 7) and creating an excellent seal with the nose 46 and cheeks, when the straps 48A,48B of overlaying facemask 47 are pulled tight. In some examples, an inferior surface of the gasket can be located in a position to be seated above, adjacent or against a portion of a superior face of the nostrils or proximate an alar groove or alar crease when worn by a user as shown in FIG. 7 (e.g., gasket 73).

FIG. 8 shows a back view of a second example of a filter assembly, in accordance with at least one example. FIG. 8 can include any of the features of the other filter assemblies described herein and therefore all elements may not be described in further detail. A filter assembly 81 can include a filter 82 and gasket 83 including tapered gasket ends 85A,85B that can include a substantially horizontal cut 814A,814B (e.g., anterior-posterior direction) forming an angle α of between 30° and 60° with the bottom of the gasket 33,43. In some examples the substantially horizontal cut 814A,814B may form an angle of approximately 45° with the bottom edge of the gasket 83 and with the tapered edge of the cut 814A,814B adjacent the top of the gasket 83 and void 84. In some examples both a vertical 313A,313B (e.g., superior-inferior direction) as shown in FIG. 3 and horizontal cut 814A,814B (e.g., anterior-posterior direction) as shown in FIG. 8 may be made at the gasket ends 85A,85B creating two planes of tapering. In some examples, the tapers in the gaskets described herein can be formed by other methods besides cutting, and the “cuts” may be planar or non-planar. In some examples, the gasket, or at least a portion of the gasket can be molded to include the tapered shape, or the gasket can include one or more elements coupled together to form the gasket.

FIG. 8 shows a back view of a second example of a filter assembly, in accordance with at least one example. FIG. 8 can include any of the features of the other filter assemblies described herein and therefore all elements may not be described in further detail. A filter assembly 81 can include a filter 82 and gasket 83 including tapered gasket ends 85A,85B that can include a substantially horizontal cut 814A,814B forming an angle α of between 30° and 60° with the bottom of the gasket 33,43. In some examples the substantially horizontal cut 814A,814B (e.g., anterior-posterior direction) may form an angle of approximately 45° with the bottom edge of the gasket 83,83 and with the tapered edge of the cut 814A,814B adjacent the top of the gasket 83 and void 84. In some examples, and as shown in FIG. 8, both a vertical 313A,313B (e.g., superior-inferior direction) and horizontal cut 814A,814B (e.g., anterior-posterior direction) may be made at the gasket ends 85A,85B creating two planes of tapering. Either or both of cuts 313A, 313B and 814A, 814B can be provided. In some examples, the tapers in the gaskets described herein can be formed by other methods besides cutting, and the “cuts” may be planar or non-planar. In some examples, the gasket, or at least a portion of the gasket can be molded to include the tapered shape, or the gasket can include one or more elements coupled together to form the gasket.

The substantially horizontally oriented gasket ends 45A,B adjacent the nose can be pressed up against the tissue supported by the nasal bone and the nasal septal cartilage, both of which create a firm anatomical structure for compressing against the gasket ends 45A,B. The firmness of the nose in this orientation not only allows an excellent air seal but also prevents a squeezing pressure against the midlevel of the nose, from obstructing breathing. This is in contrast to a squeezing pressure applied in a vertical orientation near the base of the nose (where prior art masks attempt to seal with the nose), which obstructs breathing by squeezing the compressible sides of the nose together.

Conventional nose seals, such as with the N-95 masks are a vertically oriented arch over the bridge of the nose which make the seal oriented substantially vertically relative to the nose and face of the user. The vertical orientation of the seal against the nose is substantially perpendicular to the force created by the elastic straps behind the head. Therefore, the elastic straps do not urge the N-95 mask against the nose and increasing the tightness of the straps does not increase the tightness against the nose. To compensate for this, some of these masks include a strip of malleable metal that can be formed into an arch shape over the bridge of the nose. However, the metal arch is not a spring and does not provide a compressive force of the mask against the sides of the nose. Therefore, the seal of an N-95 mask across and against the nose frequently leaks. Sealing against the nose as it transitions into the cheeks, is also well known to be the most challenging part of any facemask seal. The nearly universal fogging of the users' glasses indicates that most prior art facemasks leak around the bridge of the nose.

As shown in FIG. 1, filter 2 inserts can be rectangular in shape with rounded upper and lower edges. While this filter 2 shape may be used in some examples of this disclosure, as shown in FIG. 3, a flat bottom periphery 311 on the filter can be advantageous. In some examples, the gasket 33 at the bottom periphery 311 of the filter 32 uniquely seats against the face (not shown) just above the chin bone, against the roots of the lower incisor teeth, for the best seal. This is in contrast to prior art facemasks and N-95 respirators that extend under the chin and therefore do not have any defined structure under the jaw to create a seal against. Seating the bottom periphery 311 of the gasket 33 just above the chin bone, is also the most stable location on the lower face.

A common complaint about most facemasks and in this case the filter assembly 31, is that the filter or mask material rests directly on the lips and is particularly annoying during speaking. The invention of this disclosure uniquely solves the annoying problem of the filter or mask laying against the lips. In some examples, the gasket 33 might be between 0.25 inches and 0.75 inches high. Therefore, seating the bottom periphery 311 of the gasket 33 above the chin bone elevates the filter 32 between 0.25 inches and 0.75 inches off of the lower face and lips. The bottom periphery 311 of the foam rubber or plastic gasket 33 comfortably seats on the chin above the chin bone but the filter 32 is prevented from touching the lips or mouth and causing annoyance.

In some examples, a small breathing “chamber” is created in front of the face by wrapping the filter 32 around the tip of the nose at its upper edge, elevating the filter 32 off of the chin with the gasket 33 at its lower edge and elevating the filter 32 off of the cheeks with the gasket 33 at its side edges. The breathing chamber created by the peripheral gasket 33 allows the entire filter 32 surface within the interior of the peripheral gasket 33 to participate in air exchange. This is in contrast to prior art filters 2 that are in direct contact with the lips. With prior art filters 2, the effective filter area for air exchange may be limited to the surface area directly adjacent the mouth and lips especially when the filter is in contact with the lips, irrespective of the size of the filter. It is axiomatic that larger surface area filters are more efficient at filtration and easier to breathe through than small filters of similar material. Therefore, the breathing chamber created between the face and the filter 32 by the gasket 33 of this disclosure, maximizes the filtration efficiency and ease of breathing of any given filter material. Various masks that create breathing chambers, for example divers masks, are well known in the arts. However, a breathing chamber that utilizes the filter 32,42 as the main structural element, allowing the flexible fabric filter 32,42 to comfortably conform to the face and yet not touch the face, is unique.

Creating a seal at the bridge of the nose and another seal above the chin bone means that the height of the filter assembly 31 must be able to accommodate a variety of facial sizes or multiple filter assembly 31 sizes must be supplied. Multiple sizes add to the logistical complexity of any product and it is generally advantageous if multiple sizes can be minimized or avoided.

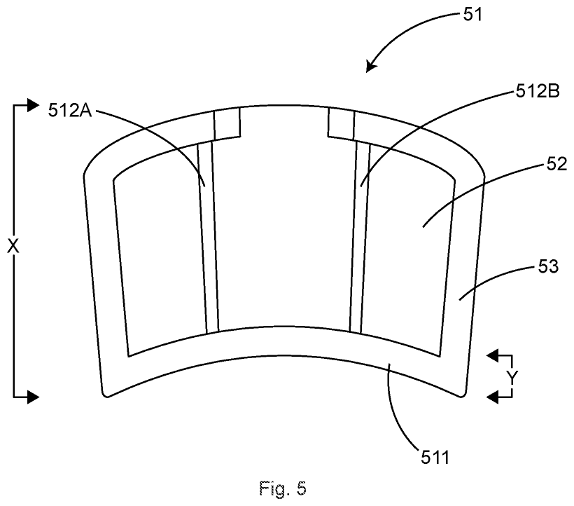

In some examples as shown in FIG. 5, the substantially flat bottom periphery 311 (bottom edge) shown in FIG. 3, allows the gasket 53 at the bottom periphery 511 to be bent upward to accommodate faces with a shorter nose-to-chin distance. For example, a substantially straight strip of compressible foam adhered to the lower edge of the filter 32,52 can be deformed into an upward curving arch shape that effectively decreases the distance from an upper edge of the filter periphery to the strip of compressible foam adhered to the lower edge of the layer of air filter material so that the filter assembly 31, 51 can adjustably fit a smaller face with a shorter distance between the midlevel of the nose and the top of the chin bone of the user. As shown in the example in FIG. 5, the nose-to-chin distance “X” may be decreased by distance “Y” by bending the lower edge upward in order to fit a smaller face. In other words, the gasket 53 along the lower edge 511 allows the filter 52 size to be uniquely adjustable for multiple facial sizes. This flexibility in sizing is unique amongst all respirators with gaskets known to these inventors.

As the lower edge gasket 511 bends upward to accommodate a smaller face, the side edges easily pull inward to accommodate the bend. In contrast, if the lower edge 511 is convex, or rounded downward, bending the gasket 511 upward to accommodate a smaller face can force the gasket material into compression causing buckling and deformation.

In some examples, as shown in FIGS. 3 and 5, struts 312A,312B and 512A, 312B may be added to filter assembly 31,51. The struts 312A,312B and 512A,512B may be two or more relatively thin strips of relatively stiff plastic sheeting. In some examples, the struts 312A,312B and 512A,512B may be in a range between 0.004 to 0.03 inch thick (4-30 mil.) and ⅛-⅜ inch wide. The struts 312A,312B and 512A,512B are flexible in their thin dimension and relatively inflexible in their thick (width) dimension. The struts 312A,312B and 512A,512B may be made of many materials including but not limited to: PVC, polyethylene, polypropylene, nylon, polyester (PET) and PETG.

In some examples, as shown in FIGS. 3 and 5, struts 312A,312B and 512A,512B may be captured or adhered between the filter 32,52 and the gasket 33,53. In this position, the struts 312A,312B and 512A,512B are adjacent the filter 32,52 and separated from the face of the user by the thickness of the gasket 33,53. The struts 312A,312B and 512A,512B can help to create and sustain the breathing chamber in front of the users face by preventing the filter 32,52 from crumpling into the breathing chamber when the overlaying facemask 47 is tightened. This may be particularly useful as shown in FIG. 5, when the lower edge gasket 511 bends upward to accommodate a smaller face. At this point, the “excess” filter material 52 can crumple or fold inward or outward but it must go in one direction or the other. Struts 312A,312B and 512A,512B can help to force the excess filter material 52 outward, away from the face of the user.

In some examples, in may be advantageous to secure any of the filter assemblies described herein, such as filter assembly 41 into the overlaying facemask 47, in order to prevent the filter assembly from shifting relative to facemask 47. To facilitate attachment, as shown in FIG. 7, one or more attachment members 714A,714B can be provided on a forward surface of the filter assembly 71 (or any of the other filter assemblies described herein). In some examples, one or more pieces, such as but not limited to two pieces, in a size range between (⅛-1 sq. inch) of pressure sensitive adhesive (PSA) may be provided (e.g., attached) to the front face of the filter 22,32. When the PSA release liner is removed by the user, the exposed PSA can be adhered to the appropriate corresponding part of the facemask. In some examples, the attachment members 714A,714B can include hook side of a hook and loop (Velcro®) and attachment may be secured by adhesive or mechanical attachment to the front face of the filter 22,32. For example, the loop side of the hook and loop attachment may be secured by adhesive or sewing to the appropriate corresponding part of the facemask. In some examples, the hook side of a hook and loop attachment may be secured to the facemask. Since high efficiency filter material is a lose, high loft nonwoven polypropylene, the hook side that is attached to the facemask can hook directly onto the high efficiency filter material as the “loop.” In some examples, the facemask 77 can include the hook portion that is attachable to the interior fabric of the facemask 77 where the interior material acts as the loop. Any suitable arrangement of hook and loop material can be provided, so long as movement of the filter assembly 71 relative to the facemask 77 is limited. Any suitable attachment member or fastening means can be employed, including magnets, snaps, clips, etc.

FIG. 7 shows a front view of an example of a user wearing a filter assembly 71 (shown in hidden view) behind facemask 77. The filter assembly 71 can include features of any of the filter assemblies described herein. Filter assembly 71 can include filter 72 and gasket 73. In some examples, the gasket 73 can be similar to or the same as the gasket 33 of FIG. 3, or the gasket 43 of FIG. 4 which can include gasket ends 35A,35B or 45A,45B, respectively. Similar to FIG. 4, FIG. 7 shows how a force 710A,710B can be applied to the nose medially to create a more effective seal against the nose compared to conventional facemasks that are more dependent on a bendable thin metal strip that does not provide a medial force against the nose. In addition, FIG. 7 illustrates an example of the location of a chin force 713 that can be applied to a user's face above the user's chin and below the lower lip. The chin force 713 can be applied in a posterior or inferior direction.

The above detailed description includes references to the accompanying drawings, which form a part of the detailed description. The drawings show, by way of illustration, specific examples in which the invention can be practiced. These examples are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other examples can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description as examples or examples, with each claim standing on its own as a separate example, and it is contemplated that such examples can be combined with each other in various combinations or permutations. The scope of the invention should be determined with reference to the appended claims, along with the full scope of equivalents to which such claims are entitled.

### Notes and Various Examples

Example 1 is a facemask filter assembly to be worn by a user, the assembly comprising: a layer of air filter material having a periphery sized to fit inside of a surgical-type facemask, the layer of air filter material having: a height equal to or greater than a distance between a midlevel of a nose and a top of a chin bone of the user; and a width greater than a distance from a first corner of a mouth of the user to a second corner of the mouth of the user; and a strip of compressible foam material coupled to the layer of air filter material near the periphery of the layer of air filter material, wherein the strip extends along the periphery of the layer of air filter material except for a gap at a midline of an upper edge of the periphery where the strip of compressible foam material is absent creating a space to accommodate the nose of the user.

In Example 2, the subject matter of Example 1 includes, wherein the layer of air filter material is a high efficiency filter made of nonwoven polypropylene fibers.

In Example 3, the subject matter of Examples 1-2 includes, wherein the layer of air filter material is an electrostatic filter.

In Example 4, the subject matter of Examples 1-3 includes, wherein the layer of air filter material is laminated to a layer of spunbond scrim fabric made of polypropylene or polyester fibers covering at least a portion of a backside of the layer of air filter material that is directly in front of the user's mouth.

In Example 5, the subject matter of Examples 1˜4 includes, wherein the layer of air filter material is laminated to a layer of meltblown nonwoven fabric made of polypropylene or polyester fibers covering an entire front face of the layer of air filter material configured to protect the layer of air filter material against salt.

In Example 6, the subject matter of Examples 1-5 includes a depth of the strip of compressible foam is between 0.25 and 0.75 inches and a height of the strip of compressible foam is between 0.25 and 0.75 inches.

In Example 7, the subject matter of Examples 1-6 includes, wherein the strip of compressible foam is made of expanded closed cell foam comprising one or more of: polyvinyl chloride, acrylonitrile butadiene, PVC, polyethylene, neoprene, urethane, silicones and blends thereof.

In Example 8, the subject matter of Examples 1-7 includes, wherein the gap at the midline of the upper edge of the layer of air filter material where the strip of compressible foam is absent in a space between 0.375 and 2.0 inches wide to accommodate the nose of the user.

In Example 9, the subject matter of Examples 1-8 includes, wherein the gap at the midline of the upper edge of the strip of compressible foam allows the layer of air filter material to wrap snuggly around a tip of the nose of the user while applying ends of the strip of compressible foam snuggly against sides of the nose of the user to create a substantially air tight seal between the facemask filter assembly and the nose.

Example 10 is a facemask filter assembly to be worn by a user, the assembly comprising: a layer of air filter material having a periphery sized to fit inside of a surgical-type facemask, the layer of air filter material having: a height equal to or greater than a distance between a midlevel of a nose and a top of a chin bone of the user; and a width greater than a distance from a first corner of a mouth of the user to a second corner of the mouth of the user; and a strip of compressible foam material coupled to the layer of air filter material near the periphery of the layer of air filter material, wherein the strip of compressible foam extends along some or all of the periphery of the layer of air filter material, wherein a height of the strip of compressible foam extends away from the layer of air filter material between 10 is missing parent: 0.25 and 10 is missing parent: 0.75 inches from a backside of the layer of air filter material, and wherein the strip of compressible foam is configured to seat against a chin of the user above the chin bone to elevate the layer of air filter material off of lips and the mouth defining a breathing chamber in front of a user's face.

In Example 11, the subject matter of Example 10 includes, wherein the breathing chamber formed in front of a user's face engages a larger surface area of the layer of air filter material to lower resistance to breathing compared to a small area of filter material or a facemask cloth applied directly against the lips and mouth.

In Example 12, the subject matter of Examples 10-11 includes, wherein the breathing chamber formed in front of a user's face engages a larger surface area of filter material for superior filtration efficiency compared to a small area of filter material or a facemask cloth applied directly against the lips and mouth.

In Example 13, the subject matter of Examples 10-12 includes, wherein the layer of air filter material is a high efficiency filter made of nonwoven polypropylene fibers.

In Example 14, the subject matter of Examples 10-13 includes, wherein a depth of the strip of compressible foam is between 0.25 and 0.75 inches and a height of the strip of compressible foam is between 0.25 and 0.75 inches.

In Example 15, the subject matter of Examples 10-14 includes, wherein the strip of compressible foam is made of expanded closed cell foam comprising one or more of: polyvinyl chloride, acrylonitrile butadiene, PVC, polyethylene, neoprene, urethane, silicones and blends thereof.

In Example 16, the subject matter of Examples 10-15 includes, further comprising a gap in the strip of compressible material located at a midline of an upper edge of the layer of air filtering material where the strip of compressible foam is absent in a space between 0.375 and 2.0 inches wide to accommodate the nose of the user.

In Example 17, the subject matter of Examples 10-16 includes, a gap in the strip of compressible material located at a midline of an upper edge of the layer of air filtering material to allow the layer of air filter material to wrap snuggly around a tip of the nose of the user while applying ends of the strip of compressible foam snuggly against sides of the nose of the user to create a substantially air tight seal between the facemask filter assembly and the nose.

In Example 18, the subject matter of Examples 10-17 includes, wherein the strip of compressible foam is adhered to the filter with adhesive, hot-melt adhesive or pressure sensitive adhesive (PSA).

Example 19 is a facemask filter assembly to be worn by a user, the assembly comprising: a layer of air filter material having a periphery sized to fit inside of a surgical-type facemask, the layer of air filter material having: a height equal to or greater than a distance between a midlevel of a nose and a top of a chin bone of the user; and a width greater than a distance from a first corner of a mouth of the user to a second corner of the mouth of the user; and a strip of compressible foam material is adhered to the layer of air filter material near the periphery of the layer of air filter material, wherein the strip of compressible foam located around some or all of the periphery of the layer of air filter material, wherein a lower edge of the layer of air filter material and adhered strip of compressible foam is substantially straight, wherein the substantially straight strip of compressible foam adhered to the lower edge of the filter can be deformed into an upward curving arch shape that effectively decreases the distance from an upper edge of the filter periphery to the strip of compressible foam adhered to the lower edge of the layer of air filter material so that the filter assembly can adjustably fit a smaller face with a shorter distance between the midlevel of the nose and the top of the chin bone of the user.

In Example 20, the subject matter of Example 19 includes, wherein the layer of air filter material is a high efficiency filter made of nonwoven polypropylene fibers.

In Example 21, the subject matter of Examples 19-20 includes, wherein a depth of the strip of compressible foam is between 0.25 and 0.75 inches and a height of the strip of compressible foam is between 0.25 and 0.75 inches.

In Example 22, the subject matter of Examples 19-21 includes, wherein the strip of compressible foam includes a gap at a midline of the upper edge of the strip of compressible foam where the strip of compressible foam is absent in a space between 0.375 and 2.0 inches wide to accommodate the nose of the user.

In Example 23, the subject matter of Examples 19-22 includes, wherein a gap at a midline of the upper edge of the layer of air filter material in the strip of compressible foam allows the layer of air filter material to wrap snuggly around a bridge of the nose of the user while applying ends of the strip of compressible foam snuggly against sides of the nose of the user to create a substantially air tight seal between the facemask filter assembly and the nose.

In Example 24, the subject matter of Examples 19-23 includes, wherein two or more flexible struts are positioned against the layer of air filter material extending from the upper edge to the lower edge of the layer of air filter material and ends of the struts are captured between the layer of air filter material and the strip of compressible foam at the upper edge and the lower edge of the layer of air filter material and the struts bend away from the user's face when the compressible foam adhered to the lower edge of the layer of air filter material is deformed into an upward curving arch shape, pushing the layer of air filter material away from the users face.

In Example 25, the subject matter of Examples 19-24 includes, wherein the strips of compressible foam at side edges of the filter can bend inward at their lower ends when the strip of compressible foam adhered to the lower edge of the layer of air filter material is deformed into an upward curving arch shape, allowing the arch shape to form smoothly.

Example 26 is a facemask filter assembly comprising: a layer of filter media having a first surface configured to face away from a user when worn, and a second surface configured to face towards the user when worn; the layer having a periphery; and a peripheral gasket coupled to the layer of filter media, wherein the peripheral gasket includes, a gap along a portion of the periphery of the filter media.

In Example 27, the subject matter of Example 26 includes, the periphery comprises a perimeter length, and wherein the gap comprises a gap length, and wherein the gap length is in a range between 3-15% of the perimeter length.

In Example 28, the subject matter of Examples 26-27 includes, wherein the layer of filter media is substantially planar.

In Example 29, the subject matter of Examples 26-28 includes, wherein the peripheral gasket includes a strip of compressible foam that is substantially planar.

In Example 30, the subject matter of Examples 26-29 includes, wherein the layer of filter material comprises a substantially uniform cross-section in a superior-inferior and anterior-posterior plane that is perpendicular to a plane of the layer of air filter material.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

1. A removable facemask insert to be worn by a user, the assembly comprising:
a layer of air filter material having a periphery sized to fit inside or beneath a surgical-type facemask, the layer of air filter material having:
a height equal to or greater than a distance between a midlevel of a nose and a top of a chin bone of the user; and
a width greater than a distance from a first corner of a mouth of the user to a second corner of the mouth of the user; and
a strip of compressible foam material coupled to the layer of air filter material near the periphery of the layer of air filter material, wherein the strip extends along the periphery of the layer of air filter material except for a gap at a midline of an upper edge of the periphery where the strip of compressible foam material is absent creating a space to accommodate the nose of the user.

2. The removable facemask insert of claim 1, wherein the layer of air filter material is a high efficiency filter made of nonwoven polypropylene fibers.

3. The removable facemask insert of claim 1, wherein the layer of air filter material is an electrostatic filter.

4. The removable facemask insert of claim 1, wherein the layer of air filter material is laminated to a layer of spunbond scrim fabric made of polypropylene or polyester fibers covering at least a portion of a backside of the layer of air filter material that is directly in front of the user's mouth.

5. The removable facemask insert of claim 1, wherein the layer of air filter material is laminated to a layer of meltblown nonwoven fabric made of polypropylene or polyester fibers covering an entire front face of the layer of air filter material configured to protect the layer of air filter material against salt.

6. The removable facemask insert of claim 1, wherein a depth of the strip of compressible foam is between 0.25 and 0.75 inches and a height of the strip of compressible foam is between 0.25 and 0.75 inches.

7. The removable facemask insert of claim 1, wherein the strip of compressible foam is made of expanded closed cell foam comprising one or more of: polyvinyl chloride, acrylonitrile butadiene, polyethylene, neoprene, urethane, silicones and blends thereof.

8. The removable facemask insert of claim 1, wherein the gap at the midline of the upper edge of the layer of air filter material where the strip of compressible foam is absent in a space between 0.375 and 2.0 inches wide to accommodate the nose of the user.

9. The removable facemask insert of claim 1, wherein the gap at the midline of the upper edge of the strip of compressible foam allows the layer of air filter material to wrap snuggly around a tip of the nose of the user while applying ends of the strip of compressible foam snuggly against sides of the nose of the user to create a substantially air tight seal between the facemask filter assembly and the nose.

10. A facemask filter assembly to be worn by a user, the assembly comprising:
a layer of air filter material having a periphery sized to fit inside of a surgical-type facemask, the layer of air filter material having:
a height equal to or greater than a distance between a midlevel of a nose and a top of a chin bone of the user; and
a width greater than a distance from a first corner of a mouth of the user to a second corner of the mouth of the user; and
a strip of compressible foam material coupled to the layer of air filter material near the periphery of the layer of air filter material, wherein the strip of compressible foam extends along some or all of the periphery of the layer of air filter material, wherein a height of the strip of compressible foam extends away from the layer of air filter material between 0.25 and 0.75 inches from a backside of the layer of air filter material, and wherein the strip of compressible foam is configured to seat against a chin of the user above the chin bone to elevate the layer of air filter material off of lips and the mouth defining a breathing chamber in front of a user's face.

11. The facemask filter assembly of claim 10, wherein the breathing chamber formed in front of a user's face engages a larger surface area of the layer of air filter material to lower resistance to breathing compared to a small area of filter material or a facemask cloth applied directly against the lips and mouth.

12. The facemask filter assembly of claim 10, wherein the breathing chamber formed in front of a user's face engages a larger surface area of filter material for superior filtration efficiency compared to a small area of filter material or a facemask cloth applied directly against the lips and mouth.

13. The facemask filter assembly of claim 10, wherein the layer of air filter material is a high efficiency filter made of nonwoven polypropylene fibers.

14. The facemask filter assembly of claim 10, wherein a depth of the strip of compressible foam is between 0.25 and 0.75 inches and a height of the strip of compressible foam is between 0.25 and 0.75 inches.

15. The facemask filter assembly of claim 10, wherein the strip of compressible foam is made of expanded closed cell foam comprising one or more of: polyvinyl chloride, acrylonitrile butadiene, PVC, polyethylene, neoprene, urethane, silicones and blends thereof.

16. The facemask filter assembly of claim 10, further comprising a gap in the strip of compressible material located at a midline of an upper edge of the layer of air filtering material where the strip of compressible foam is absent in a space between 0.375 and 2.0 inches wide to accommodate the nose of the user.

17. The facemask filter assembly of claim 10, further comprising a gap in the strip of compressible material located at a midline of an upper edge of the layer of air filtering material to allow the layer of air filter material to wrap snuggly around a tip of the nose of the user while applying ends of the strip of compressible foam snuggly against sides of the nose of the user to create a substantially air tight seal between the facemask filter assembly and the nose.

18. The facemask filter assembly of claim 10, wherein the strip of compressible foam is adhered to the filter with adhesive, hot-melt adhesive or pressure sensitive adhesive (PSA).

19. A facemask filter assembly to be worn by a user, the assembly comprising:
a layer of air filter material having a periphery sized to fit inside of a surgical-type facemask, the layer of air filter material having:
a height equal to or greater than a distance between a midlevel of a nose and a top of a chin bone of the user; and
a width greater than a distance from a first corner of a mouth of the user to a second corner of the mouth of the user; and
a strip of compressible foam material is adhered to the layer of air filter material near the periphery of the layer of air filter material, wherein the strip of compressible foam located around some or all of the periphery of the layer of air filter material, wherein a lower edge of the layer of air filter material and adhered strip of compressible foam is substantially straight, wherein the substantially straight strip of compressible foam adhered to the lower edge of the filter can be deformed into an upward curving arch shape that effectively decreases the distance from an upper edge of the filter periphery to the strip of compressible foam adhered to the lower edge of the layer of air filter material so that the filter assembly can adjustably fit a smaller face with a shorter distance between the midlevel of the nose and the top of the chin bone of the user.

20. The facemask filter assembly of claim 19, wherein the layer of air filter material is a high efficiency filter made of nonwoven polypropylene fibers.

21. The facemask filter assembly of claim 19, wherein a depth of the strip of compressible foam is between 0.25 and 0.75 inches and a height of the strip of compressible foam is between 0.25 and 0.75 inches.

22. The facemask filter assembly of claim 19, wherein the strip of compressible foam includes a gap at a midline of the upper edge of the strip of compressible foam where the strip of compressible foam is absent in a space between 0.375 and 2.0 inches wide to accommodate the nose of the user.

23. The facemask filter assembly of claim 19, wherein a gap at a midline of the upper edge of the layer of air filter material in the strip of compressible foam allows the layer of air filter material to wrap snuggly around a bridge of the nose of the user while applying ends of the strip of compressible foam snuggly against sides of the nose of the user to create a substantially air tight seal between the facemask filter assembly and the nose.

24. The facemask filter assembly of claim 19, wherein two or more flexible struts are positioned against the layer of air filter material extending from the upper edge to the lower edge of the layer of air filter material and ends of the struts are captured between the layer of air filter material and the strip of compressible foam at the upper edge and the lower edge of the layer of air filter material and the struts bend away from the user's face when the compressible foam adhered to the lower edge of the layer of air filter material is deformed into an upward curving arch shape, pushing the layer of air filter material away from the users face.

25. The facemask filter assembly of claim 19, wherein the strips of compressible foam at side edges of the filter can bend inward at their lower ends when the strip of compressible foam adhered to the lower edge of the layer of air filter material is deformed into an upward curving arch shape, allowing the arch shape to form smoothly.

26. An insert filter for a facemask, comprising:
a layer of filter media having a first surface configured to face away from a user when worn, and a second surface configured to face towards the user when worn, the layer having a periphery; and
a peripheral gasket of compressible foam coupled to the layer of filter media, wherein the peripheral gasket includes a gap along a portion of the periphery of the filter media, wherein the peripheral gasket is configured to seat against a chin of the user above the chin bone to elevate the layer of air filter material off of lips and the mouth defining a breathing chamber in front of a user's face.

27. The insert filter for a facemask of claim 26, wherein the periphery comprises a perimeter length, and wherein the gap comprises a gap length, and wherein the gap length is in a range between 3-15% of the perimeter length.

28. The insert filter for a facemask of claim 26, wherein the layer of filter media is substantially planar.

29. The insert filter for a facemask of claim 26, wherein the peripheral gasket includes a strip of compressible foam that is substantially planar.

30. The insert filter for a facemask of claim 26, wherein the layer of filter material comprises a substantially uniform cross-section in a superior-inferior and anterior-posterior plane that is perpendicular to a plane of the layer of air filter material.
